(19) United States
(12) Patent Application Publication
(10) Pub. No.: US 2009/0223482 A1
(43) Pub. Date: Sep. 10, 2009

(54) METHOD FOR IMPROVING AN INTERNAL COMBUSTION ENGINE

(76) Inventor: Gerhard Schmitz, Saint-Vith (BE)

Correspondence Address: Cozen O''Connor, 250 PARK AVENUE, NEW YORK, NY, 10177, US

(21) Appl. No.: 12/125,252

(22) Filed: May 22, 2008

(30) Foreign Application Priority Data
May 24, 2007 (BE) 2007/0255

(51) Int. Cl. F02B 75/02

(52) U.S. Cl. 123/311

(57) ABSTRACT

The invention relates to a method for improving an internal combustion engine using:
a) on the one hand at least one cylinder (1) functioning as a low-pressure cylinder according to a two-stroke operation, and
b) on the other hand, two cylinders (2, 3) functioning as high-pressure combustion cylinders according to a four-stroke operation, the capacity displacement of each of the cylinders (2, 3) being less than that of the low-pressure cylinder (1), the combustion cylinders (2, 3) delivering alternatively their combusted gases towards the low-pressure cylinder (1) for a second expansion of the combusted gases.

The invention is characterized in that the total expansion rate, defined hereinabove, is increased by having intervene a portion of the capacity displacement of the high-pressure cylinders in the maximum expansion volume and this, without increasing the capacity displacement of said engine, or the compression ratio of the high-pressure cylinders, or the dead volume of the low-pressure cylinder, or the volume of the transfer channel of the combusted gases of the high-pressure cylinders towards the low-pressure cylinder.

The invention also relates to an internal combustion engine for implementing this method having intervene a “90° crankshaft” and/or “a shifting of the cylinders”.

This invention relates to, in general, a method for improving an internal combustion engine.

More precisely, the invention relates to a method for improving an internal combustion engine of the type comprising at least one cylinder which includes a variable volume working chamber by the displacement in this cylinder of a piston between a top dead center position and a bottom dead center position, to each such cylinder being associated means of admitting and of evacuating a gaseous fluid, the piston of each such cylinder being connected to a crankshaft of said engine, this engine using:

a) on the one hand, at least one such cylinder functioning as a low-pressure cylinder according to a two-stroke operation, which includes the intake accompanied by the expansion producing a useful work during each stroke of the piston of this low-pressure cylinder towards its bottom dead center and the exhaust of a gaseous fluid during each stroke of the piston towards its top dead center, and,

b) on the other hand, two such cylinders functioning as high-pressure combustion cylinders according to a four-stroke operation, which includes the intake of air or of an air-fuel mixture during the first stroke of the piston of each of said combustion cylinders towards its bottom dead center, the compression of the air or of an air-fuel mixture during the first stroke of the piston towards its top dead center, followed by the combustion, the expansion of the combusted gases during the second stroke of the piston towards its bottom dead center producing a useful work and the delivery of the combusted gases during the second stroke of the piston towards its top dead center, the capacity displacement of each of the combustion cylinders being less than that of the low-pressure cylinder, these combustion cylinders, also referred to as high-pressure cylinders, delivering alternatively their combusted gases towards the low-pressure cylinder for a second expansion of the combusted gases.

The five-stroke internal combustion engine, described in European patent 1201892 (Gerhard Schmitz) or U.S. Pat. No. 6,553,977 (Gerhard Schmitz) is basically an engine with three cylinders arranged in lines. The two cylinders at the ends of the crankshaft, called the high-pressure cylinders (HP cylinders), have capacity displacements equal to and much smaller than that of the central cylinder, called the low-pressure cylinder (LP cylinder). The two pistons of the HP cylinders move in perfect phase in relation to one another and in inversion of phase in relation to the piston of the LP cylinder. The two HP cylinders are supplied, more preferably with a pre-compressed air/fuel mixture during the first downstroke of the piston of the HP cylinder. When coming back up the first time, the piston of the HP cylinder compresses the air/fuel mixture intake, this mixture being burned when the piston of the HP cylinder is close to its top dead center (TDC), which causes the pressure inside the HP cylinder to increase sharply. This combusted gas is expanded a first time during the second downstroke of the piston of the HP cylinder. When the piston of the HP cylinder reaches its bottom dead center (BDC), the piston of the LP cylinder is approaching its TDC: at this moment, a communication between the HP cylinder and the LP cylinder is established. During the second stroke of the piston of the HP cylinder towards its TDC, the piston of the LP cylinder descending towards its BDC, the combusted gas is transferred from the HP cylinder to the LP cylinder and, the capacity displacement of the LP cylinder being clearly greater than that of the HP cylinder, the combusted gas is expanded a second time. When the piston of the HP cylinder reaches its TDC and the piston of the LP cylinder its BDC, the communication between the HP and LP cylinders will be interrupted while the exhaust valve of the LP cylinder will start to open and will remain as such during the upward stroke of the piston of the LP cylinder in order to allow for the exhaust of the combusted gases from the engine. At the same time, the piston of the HP cylinder descends again and begins a new cycle through the intake of a new air/fuel mixture. The other HP cylinder carries out the same cycle as the first HP cylinder, but with a delay equal to an angle of 360° at the level of the crankshaft in relation to first, in such a way that the second HP cylinder can transfer its combusted gases to the same LP cylinder while the piston of the latter descends the second time, and so on.

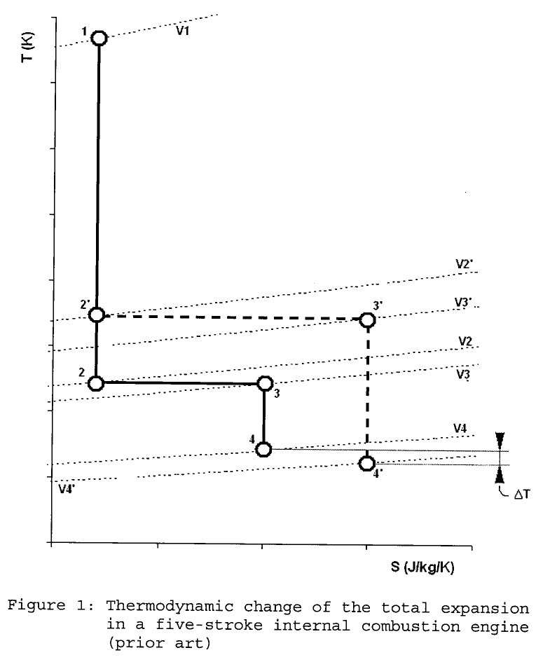

The total expansion in the five-stroke internal combustion engine takes place, consequently, in three stages as shown in FIG. 1, in the annex, which constitutes a graphical representation of the thermodynamic change of this total expansion:

1. Expansion in the HP cylinder or change from 1 or “state 1” to 2 or “state 2”, i.e. the expansion that takes place in the high-pressure cylinder when the piston moves from its TDC (state 1) to the position that it will occupy when the communication between the HP cylinder and the adjacent LP cylinder (state 2) is established. This expansion will take place isentropically ideally.

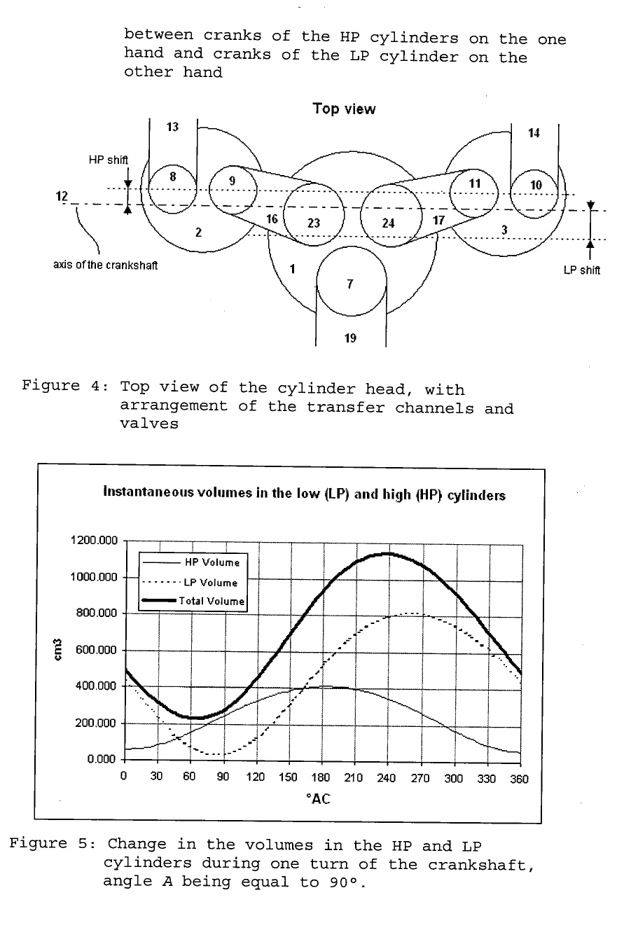

2. Pressurization in the LP cylinder or change in the state 2 to the state 3, i.e. instantaneous distribution of the combusted gases in the two cylinders at the time of the placing into communication of the two HP and LP cylinders, i.e. opening of the exhaust valve of the HP cylinder (valve analogous to 9, 11 in FIGS. 4 and 9 to 15 in the annex) and possibly of the corresponding intake valve of the LP cylinder (valve analogous to 23, 24 in FIGS. 4 and 9 to 11 in the annex), the piston of the LP cylinder located at its TDC. This expansion will be better described by an isothermal expansion, without the production of useful work.

3. Expansion in the LP cylinder or change from state 3 to state 4, i.e. expansion that will take place while the piston of the LP cylinder is performing its downstroke to its BDC, with the communication between the HP and LP cylinders remaining established.

The decisive total expansion ratio or rate determines the quantity of mechanical work that can be produced during the expansion of the combusted gases in such a five-stroke engine following a drop in temperature from T1 to T4. This rate is defined in the following manner (see FIG. 1):

Total expansion ratio=expansion rate in the HP cylinder×expansion rate in the LP cylinder=(V2/V1)×(V4/V3)

where the “expansion rate in the HP cylinder” is equal to the intermediate volume of the HP cylinder (V2) divided by the dead volume (V1) of this HP cylinder (the volume of the combustion chamber), said intermediate volume being equal to the contents of the HP cylinder at the time of the placing into communication of the HP and LP cylinders, and

where the “expansion rate in the LP cylinder” is equal to the maximum of the volume total (V4) contained in the HP cylinder, in the transfer channel and in the LP cylinder as well, this maximum being reached during the downstroke of the piston of the LP cylinder, divided by the intermediate volume defined hereinabove and by adding to it the volume of the transfer channel of the combusted gases of the HP cylinder to the LP cylinder and the dead volume of the LP cylinder (V3).

In the case of a five-stroke internal combustion engine according to prior art, the movement of the pistons of the HP and LP cylinders, in inversion of phase, results in the following situation: the maximum expansion volume in the LP cylinder (V4) is reached when the piston of this LP cylinder is located at its BDC, the piston of the HP cylinder being located, consequently, at its TDC. In such a situation, the HP capacity displacement does not participate at all in this maximum decisive volume.

This invention has for purpose to prose a method that makes it possible to improve the internal combustion engine, of the type mentioned previously, by acting on the ratio of total decisive expansion in such a way as to increase the quantity of mechanical work produced during the expansion of the combusted gases.

In order to fulfill this purpose, the method according to the invention is characterized in that the total expansion rate, defined hereinabove, is increased by having intervene a portion of the capacity displacement of the high-pressure cylinders (HP capacity displacement) in the maximum expansion volume and this, without increasing the capacity displacement of said engine, or the compression ratio of the high-pressure cylinders (HP), or the dead volume of the low-pressure cylinder (LP), or the volume of the transfer channel of the combusted gases of the HP cylinders towards the LP cylinder.

Furthermore, according to another of its characteristics, this invention proposes several embodiments of an engine of the type mentioned previously, for the implementation of the method of the invention having intervene a portion of the capacity displacement of the HP cylinders in the volume maximal (V4) of the total expansion:

### 90° Crankshaft:

According to a first embodiment of the invention, the internal combustion engine of the type mentioned previously is characterized in that the cranks of the crankshaft, to which are connected the connecting rods attached to the pistons of the high-pressure cylinders (HP) supplying alternatively the same low-pressure cylinder (LP), are parallel in relation to one another and form with the crank, to which is connected the connecting rod attached to the piston of said low-pressure cylinder, an angle substantially smaller than 180°, i.e. an angle of a magnitude of 90°, in such a way that the piston of this low-pressure cylinder reaches its top dead center (TDC) substantially before the pistons of the adjacent high-pressure cylinders reach their respective bottom dead center (BDC).

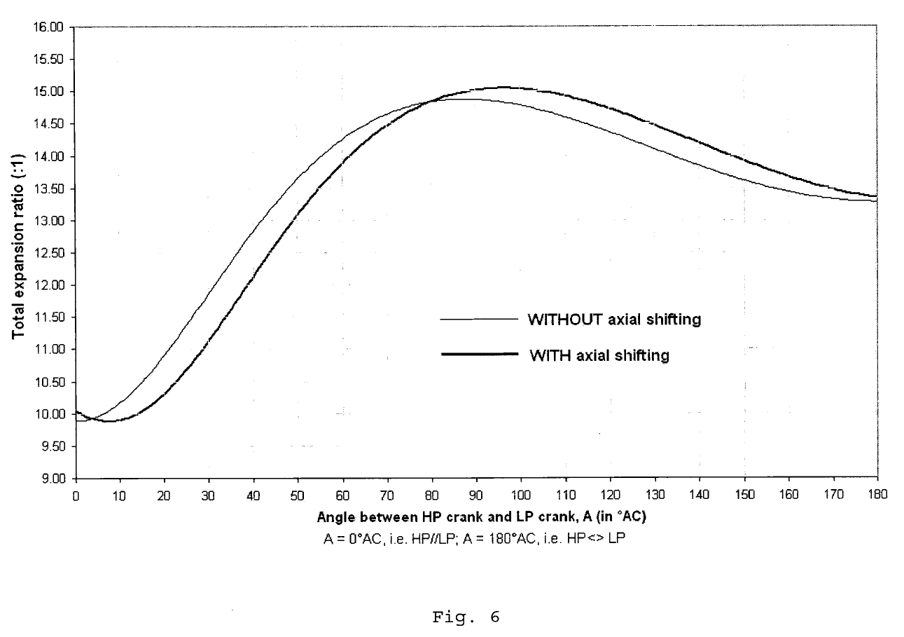

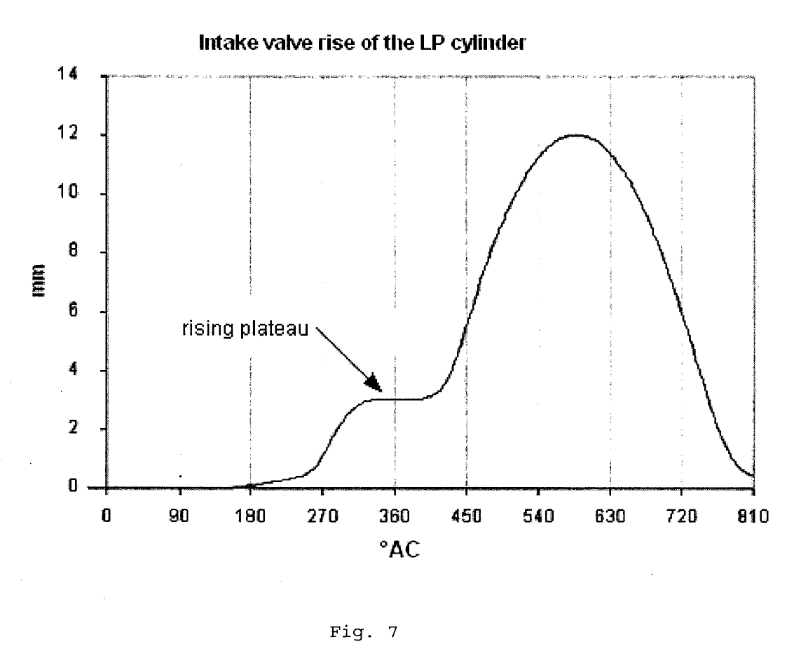

In this arrangement, the volume maximal (V4) will be obtained at the instant, when the crank connecting the piston of the LP cylinder to the crankshaft is located in a position of a magnitude of 30° AC (angle of the crankshaft) before its BDC position (see FIG. 5). This is due to the fact that the speeds of the pistons of the HP and LP cylinders are not uniform due to the rod/crank kinetics. If for mechanical and thermodynamic reasons the other geometric parameters are fixed, i.e. the capacity displacements of the HP and LP cylinders, the volume compression ratios of the HP and LP cylinders, the volume of the transfer channel, the rod/crank ratios, the total expansion rate is a function, in this case, only of angle A, angle formed by the cranks of the HP cylinders (parallel in relation to one another) with the cranks of the LP cylinder connected to the piston of the corresponding LP cylinder (see FIG. 3 and FIG. 6). In the case where these other geometric parameters have current values, even those technically possible, i.e. a volumetric compression and/or expansion ratio of the LP cylinder of a magnitude of 32 and a volume of the transfer channel equal to approximately 6% of the capacity displacement of the LP cylinder, this total expansion ratio of the engine is reached if angle A is close to 90°.

### Cylinder Shifting:

According to another embodiment of the invention, the internal combustion engine of the type mentioned previously is characterized in that on the one hand, the axis of the high-pressure cylinders (HP) is displaced in relation to the axis of the crankshaft in such a way that the crank, whereto is attached the connecting rod of the high-pressure cylinder, is located on the same side, in relation to the axis of said crankshaft, as the axis of said high-pressure cylinder at the moment when the piston of this high-pressure cylinder, being located midway between its top dead center and its bottom dead center, is in the process of descending and on the other hand, the axis of the low-pressure cylinder is displaced in relation to the axis of said crankshaft in such a way that the crank, whereto is attached the connecting rod of the piston of this low-pressure cylinder, is located on the same side, in relation to the axis of this crankshaft, as the axis of the low-pressure cylinder at the moment when the piston of this low-pressure cylinder, being located midway between its bottom dead center and its top dead center, is in the processes of ascending.

Due to the fact that the volume maximal during the second expansion is already reached before the piston of the LP cylinder reaches its BDC, the available time for the exhaust can be increased by this interval of temps taken by the piston to reach its BDC or, in another manner, the opening of the exhaust valve(s) of the LP cylinder can be as such advanced by approximately 30° AC. The evacuation of the residual combusted gases from the combustion chamber of the HP cylinder can also be improved thanks to this advancing of the exhaust opening of the LP cylinder. Indeed, the aforementioned total maximum volume is reached when the piston of the HP cylinder is located hardly at half-height in its cylinder, at the moment when the exhaust of the gases from the LP cylinder will start. The communication between the HP and LP cylinders remaining established during the remaining rising of the piston of the HP cylinder, this time can be taken advantage of for a more effective exhaust of the residual combusted gases from the combustion chamber of the HP cylinder in order to reduce as much as possible the portion of the residual combusted gases in the fresh charge to be ignited during the next cycle.

The second expansion of the initial five-stroke cycle starts at the moment when the piston of the descending HP cylinder is located midway between its TDC and its BDC. Consequently, the first expansion, which takes place solely in the HP cylinder, is accomplished only halfway at the moment when the second expansion begins that has the two HP and LP cylinders intervene. For this reason, the internal combustion engine according to the invention can be qualified as a “four-and-a-half-stroke internal combustion engine”. This “coming together” of the cycles, taking place in the high and low pressure portions, in addition has the effect of reducing the total residence time of the combusted gases under pressure inside the engine, i.e. the time that elapses between the lighting and the opening of the exhaust valve. This residence time is of a magnitude of 360° AC (angle of the crankshaft) in the five-stroke internal combustion engine and will be only 270° AC in the engine according to this invention. Consequently, the total heat loss through the walls of the engine block will be reduced. Indeed, the total level of temperature and of pressure not being altered by the modification in question, the heat loss through the walls will be reduced by the simple effect of a reduced residence time.

The embodiments of an internal combustion engine described previously for the implementation of the method of the invention have either a “90° crankshaft” (preceding paragraph A.) or a “shift in cylinders” (preceding paragraph B.) intervene.

However, according to an additional alternative, the internal combustion engine of the type mentioned previously, comprises “a 90° crankshaft” as well as “a shift in cylinders” as described in paragraphs A. and B. in question.

Consequently, according to another embodiment of the invention, the internal combustion engine of the type mentioned previously is characterized in that:

a) the cranks of the crankshaft, to which are connected the connecting rods attached to the pistons of the high-pressure cylinders supplying alternatively the same low-pressure cylinder, are parallel in relation to one another and form with the crank, to which is connected the connecting rod attached to the piston of said low-pressure cylinder, an angle of a magnitude of 90° in such a way that the piston of this low-pressure cylinder reaches its top dead center substantially before the pistons of the adjacent high-pressure cylinders reach their respective bottom dead center,

and

b) on the one hand the axis of the high-pressure cylinders is displaced in relation to the axis of the crankshaft in such a way that the crank, whereto is attached the connecting rod of the piston of the high-pressure cylinder, is located on the same side, in relation to the axis of said crankshaft, as the axis of this high-pressure cylinder at the moment when the piston of this high-pressure cylinder, being located midway between its top dead center and its bottom dead center, is in the process of descending, and on the other hand the axis of the low-pressure cylinder is displaced in relation to the axis of said crankshaft in such a way that the crank, whereto is attached connecting rod of the piston of said low-pressure cylinder, is located on the same side, in relation to the axis of this crankshaft, as the axis of this low-pressure cylinder at the moment when the piston of this low-pressure cylinder, being located midway between its bottom dead center and its top dead center, is in the process of ascending.

Furthermore, according to another characteristic of the invention, the internal combustion engine of the type mentioned previously, comprises two groups of three inline cylinders, these groups forming an angle between themselves of 180° and being located on either side of a single three-crank crankshaft, the two cranks being located at the ends of this crankshaft being parallel and connected to the pistons of the high-pressure cylinders by the corresponding connecting rods, the third crank being located in the middle and being connected to the pistons of the low-pressure cylinders by the corresponding connecting rods, this last crank forming an angle of approximately 90° with the other two cranks, in such a way that the pistons of the low-pressure cylinders reach their respective top dead center substantially before the pistons of the adjacent high-pressure cylinders reach their respective bottom dead center.

Moreover, according to another characteristic of the invention, the internal combustion engine of the type mentioned previously comprises transfer channels which each include a main transfer valve, or exhaust valve of the high-pressure cylinder, and an auxiliary transfer valve which functions as an intake valve of the low-pressure cylinder, the main transfer valve and this auxiliary transfer valve of the transfer channel which opens into the corresponding high-pressure cylinder being configured in such a way that said auxiliary valve opens substantially before the piston of the low-pressure cylinder reaches its top dead center, instant close to which will start the transfer of the combusted gases of the corresponding high-pressure cylinder through said transfer channel in such a way that this transfer channel is pressurized by a portion of the residual combusted gases contained in the low-pressure cylinder before the opening of the main transfer valve functioning as an exhaust valve of said corresponding high-pressure cylinder and blocking said transfer channel on the side of this high-pressure cylinder and without too greatly increasing the depth of the valve pocket arranged in the upper surface of the piston of the low-pressure cylinder in order to avoid all contact between the auxiliary transfer valve and the piston of the low-pressure cylinder.

Furthermore, according to an additional characteristic of the invention, the low-pressure cylinder of the internal combustion engine comprises one or several exhaust valves controlled by a camshaft turning at the speed of the crankshaft.

On the other hand, according to another characteristic of the invention, the camshaft in question is equipped with balance weights arranged and dimensioned in such a way as to reduce the vibrations of the engine generated by other existing weights and displacing at the rotation frequency of the crankshaft.

The invention will be better understood and other purposes, characteristics and advantages of the latter will appear more clearly in the description that follows in reference to the schematic drawings provides solely by way of examples showing the embodiments of the invention and wherein:

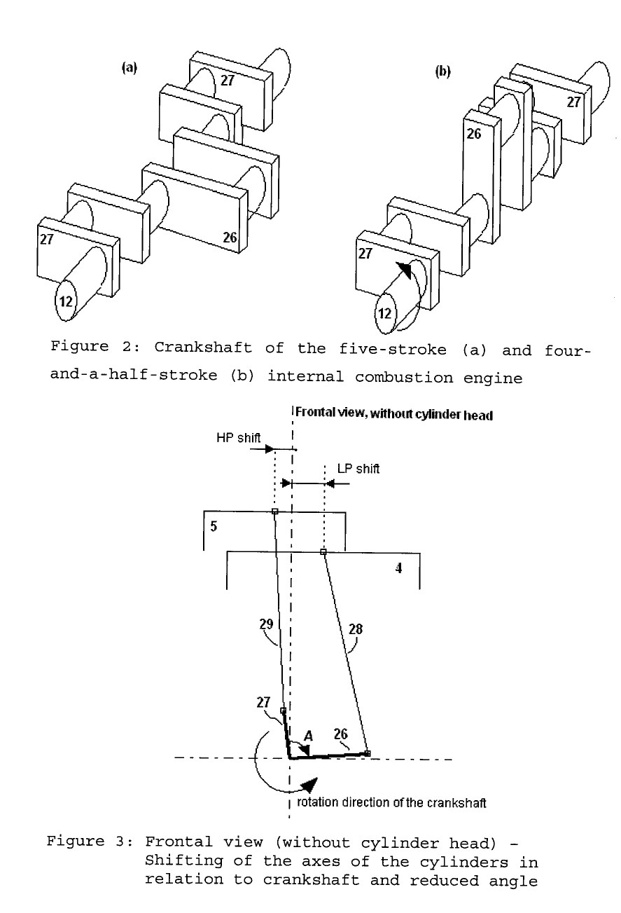

FIG. 2a is a schematic and perspective representation of the crankshaft of a five-stroke internal combustion engine according to prior art,

FIG. 2b is a schematic and perspective representation of the crankshaft of a four-and-a-half-stroke internal combustion engine according to the invention,

FIG. 3 is a frontal schematic representation of the axes of the cylinders without cylinder head in relation to the crankshaft and of the angle A between the cranks of the HP cylinders on the one hand and the crank of the LP cylinder on the other hand,

FIG. 4 is a planar schematic view of the cylinder head of the HP cylinders and of the LP cylinder, with arrangement of the transfer channels and valves,

FIG. 5 is a graphical representation of the diagram showing the change in the volumes in the LP cylinder and the HP cylinders during one crankshaft turn, the angle A between the cranks of the HP cylinders and the crank of the LP cylinder being equal to 90°,

FIG. 6 is a graphical representation of the total expansion ratio in function of the angle A between the cranks of the HP cylinders and the crank of the LP cylinder,

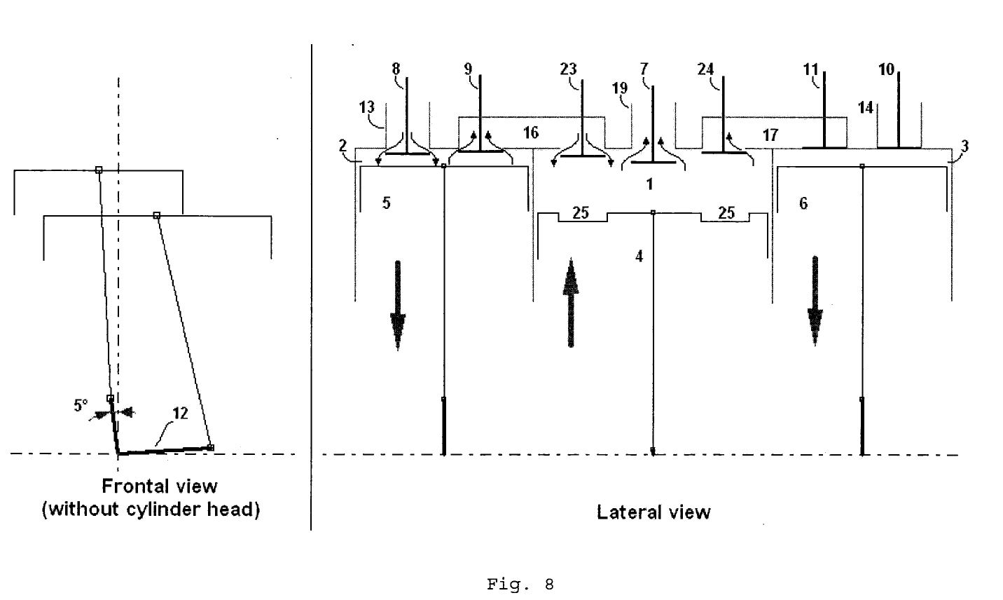

FIG. 7 is a graphical representation of the rising of the auxiliary transfer valve of the LP cylinder with “plateau”,

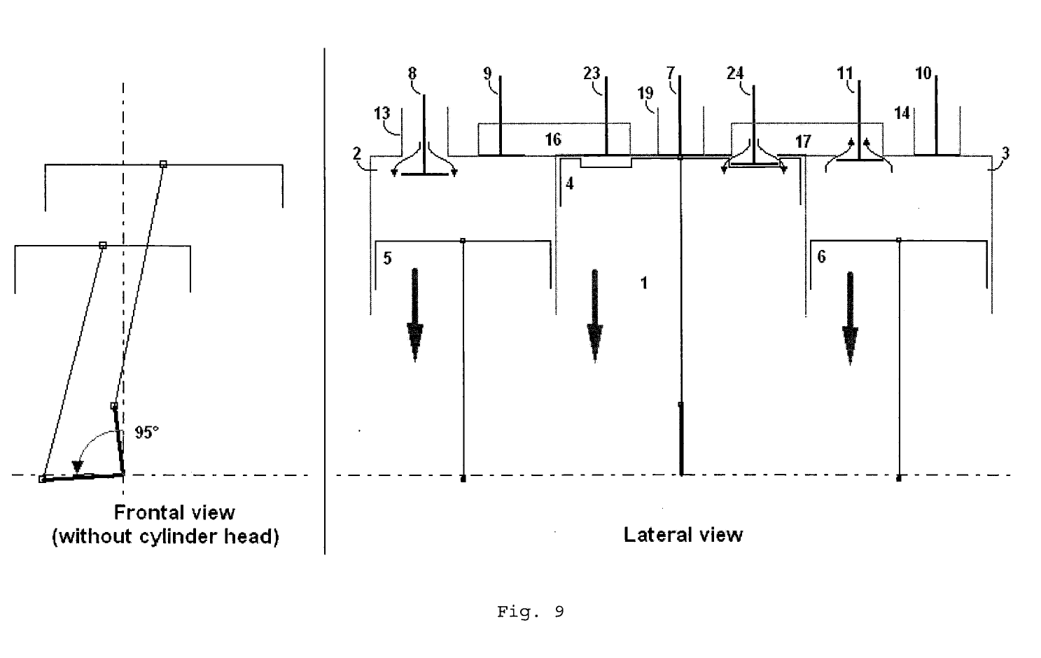

FIGS. 8 to 15 are respectively frontal and lateral views of the engine according to the invention with crankshaft at respectively 5°, 95°, 185°, 275°, 365°, 455°, 545°, 635° after the TDC (intake into the left HP cylinder),

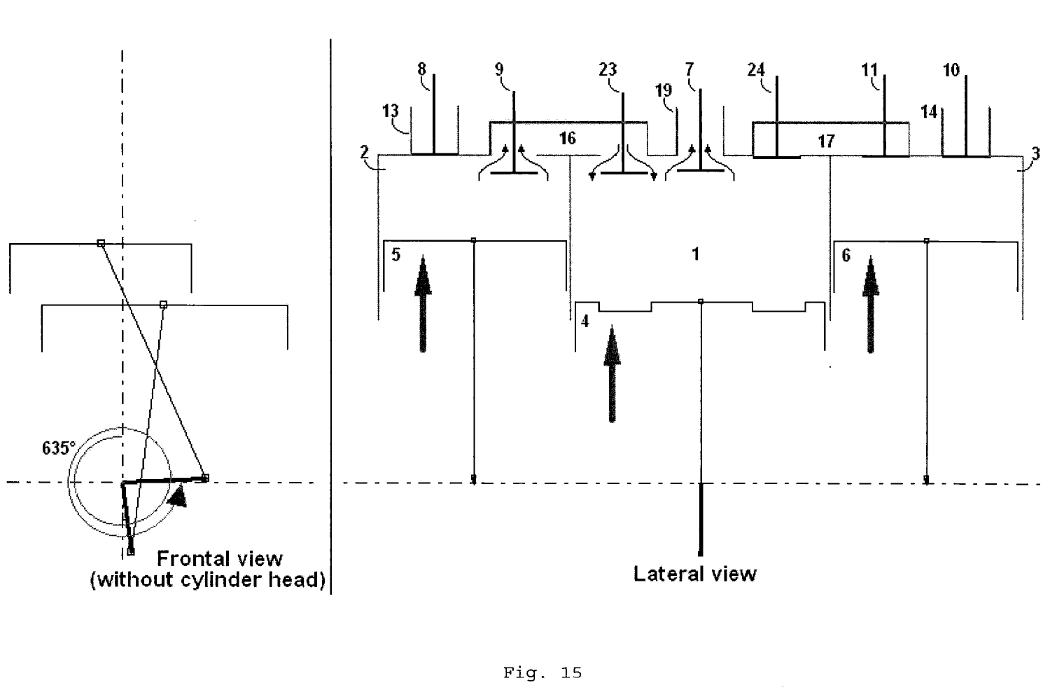

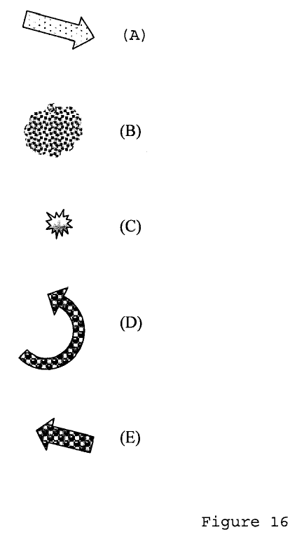

FIG. 16 is a graphical key for the description of the operation of the internal combustion engine in FIGS. 17 to 20,

FIGS. 17 to 20 are schematic representations of the operation of a four-and-a-half-stroke internal combustion engine comprising two groups of 3 opposed cylinders and of which the crankshaft is positioned at 0°, 90°, 180° and 270° respectively.

In these figures, different elements of the engine according to the invention are represented schematically and are referenced as follows:

1: low-pressure cylinder

2: high-pressure cylinder

3: high-pressure cylinder

4: piston of the low-pressure cylinder

5: piston of the high-pressure cylinder

6: piston of the high-pressure cylinder

7: exhaust valve of the low-pressure cylinder

8: intake valve of the high-pressure cylinder

9: main transfer valve or exhaust valve of the high-pressure cylinder

10: intake valve of the high-pressure cylinder

11: main transfer valve or exhaust valve of the high-pressure cylinder

12: crankshaft

13: inlet manifold of the high-pressure cylinder

14: inlet manifold of the high-pressure cylinder

16: transfer channel

17: transfer channel

19: exhaust manifold of the low-pressure cylinder

23: auxiliary transfer valve or intake valve of the low-pressure cylinder

24: auxiliary transfer valve or intake valve of the low-pressure cylinder

25: valve pocket

26: connecting rod to which is attached the piston of the low-pressure cylinder

27: connecting rod to which is attached the piston of the high-pressure cylinder

28: connecting rod of the low-pressure cylinder

29: connecting rod of the high-pressure cylinder

As shown in FIG. 2(a), the angle between the cranks 27 connected to the pistons of the HP cylinders and the crank 26 connected to the piston of the LP cylinder is equal to 180° in the five-stroke engine of prior art. However, in the four-and-a-half-stroke engine of the invention, this angle, visible in FIG. 2(b) and shown by the angle A in FIG. 3, is highly reduced to a value close to 90°, in such a way that the “delay” of the piston 4 of the LP cylinder on the pistons 5 of the HP cylinders is reduced.

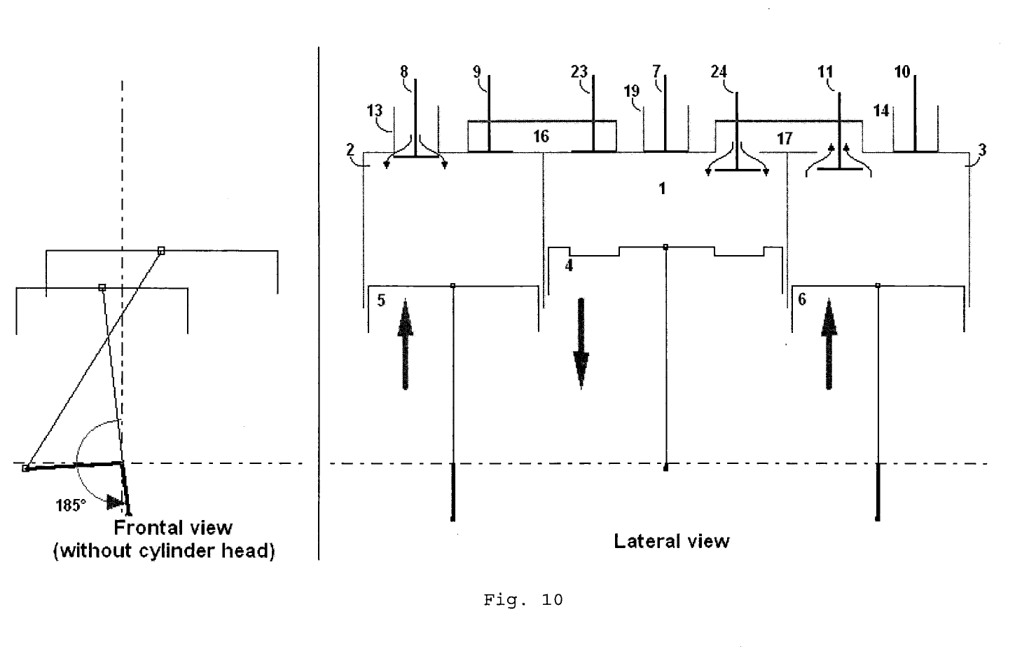

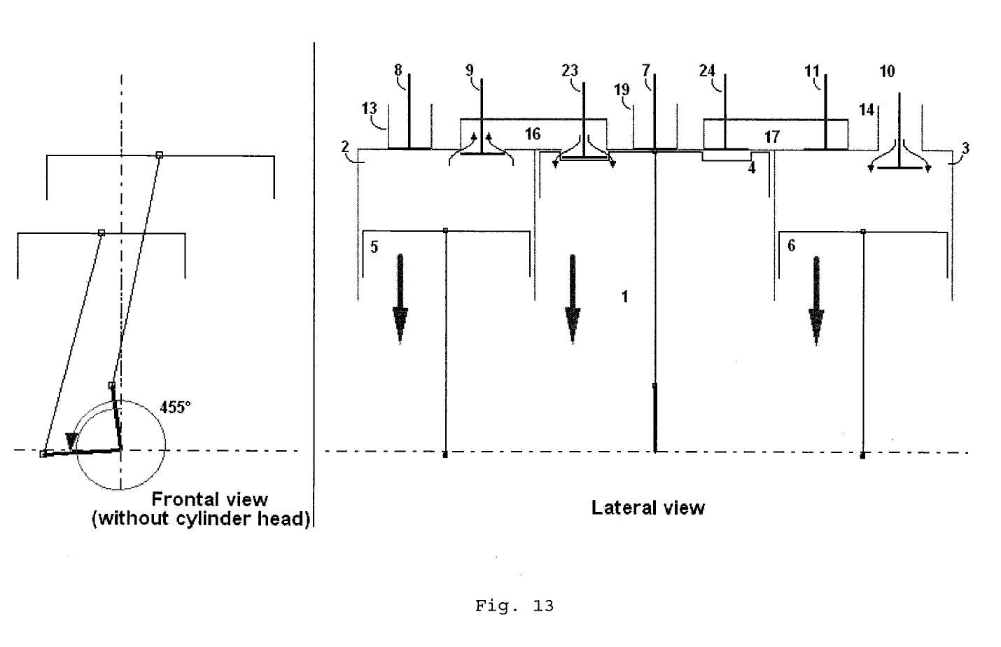

On the other hand, as shown in FIG. 4, the shifting of the axes of the HP cylinders 2, 3 and the shifting of the axis of the LP cylinder 1 are located on either side of the axis of the crankshaft 12. These shifts make it possible to optimize the arrangement of the valves of the LP cylinder with the purpose of taking full advantage of the available space by simultaneously decreasing and as much as possible the volume of the transfer channels 16, 17 and this, by reducing their lengths as much as possible (see FIG. 4). Each transfer channel 16, 17 connecting a HP cylinder to the LP cylinder can be equipped with an auxiliary valve, the latter being referenced 23 and 24 respectively in FIG. 4, which equivocates to providing the LP cylinder with two intake valves for the combusted gases. The rising of the latter is characterized by the appearance of a “plateau” on the opening side in such a way that the opening of the valve in question can be advanced in relation to the TDC of the LP piston without the valve pockets 25, in FIG. 8, arranged in the upper face of the piston 4 of the LP cylinder in order to be able to receive the valves, becoming too deep (see FIG. 9, valve 24 as well as FIG. 13, valve 23). This advancing of the opening of the valves in question is used to pressurize the transfer channel in question just before the connection between the HP and LP cylinders through the channel in question is accomplished. This provides a thermodynamic advantage by avoiding an unfavorable increase in entropy, which would be the consequence of an excessive drop in pressure at the moment of the opening of the exhaust valve of the HP cylinder.

A four-and-a-half-stroke engine, according to the invention, designed in the form of an engine with two groups of 3 opposite cylinders with a crankshaft, of which the angle between the cranks of the HP and LP cylinders is 90°, has the advantage of accomplishing a power stroke every 90° of the angle of the crankshaft (FIGS. 16 to 20). In this embodiment the crankshaft is constituted of three cranks. The two cranks being located at the ends of this crankshaft are each connected to the pistons of the two HP cylinders which move in the corresponding cylinders arranged in an opposing manner. The central crank is connected to the pistons of the two LP cylinders which, also, move in two LP cylinders arranged in an opposing manner. In such an embodiment of the four-and-a-half-stroke engine, it will be difficult to take advantage of the benefits provided by shifting the axes of the cylinders in relation to the axis of the crankshaft. Indeed, if it proves useful to take advantage of this shifting, it will appear necessary to position the exhaust valves of the LP cylinders of the two sides of the engine block (for one LP cylinder “above” and for the other LP cylinder “below” the engine block). This will result in an arrangement of the exhaust manifolds that is less favorable from a spatial arrangement standpoint.

In the case where two camshafts are present, of which one controls only the exhaust valves of the LP cylinder, the latter can turn at the speed of the crankshaft, since the exhaust valve(s) of the LP cylinder must open at each tour of the crankshaft, this LP cylinder working in fact following a two-stroke cycle, if it is considered in an isolated manner. This modification does not add any benefit to the thermodynamic cycle, but allows for an advantageous cam profile in terms of the contact pressure between cam and support (Hertz pressure). As this shaft turns at the speed of the crankshaft, it is possible to consider taking advantage of this in order to provide here weights to balance the mechanical forces generated by the weights that move at the rotation frequency of the crankshaft, i.e. the pistons and the cranks of the crankshaft itself.

### DETAILED DESCRIPTION OF THE THERMODYNAMIC CYCLES IN THE ENGINE ACCORDING TO THE INVENTION WITH THREE CYLINDERS

The thermodynamic cycles which are accomplished during an implementation of the engine according to the invention in the case where the latter corresponds to a three-cylinder engine and of which the angle between the cranks of the HP cylinders and the crank of the LP cylinder of the crankshaft 12 is equal to 90°, are described in detail hereinafter in reference to FIGS. 8 to 15. The latter show respectively a frontal schematic view (without cylinder head) and a lateral schematic view of the three-cylinder four-and-a-half-stroke engine for a given angular position of the crankshaft.

FIG. 8. The cranks of the HP cylinders are located at an angle equal to 5° in relation to the upper vertical position. The piston 5 of the HP cylinder 2, located on the left in the figure, starts its descent and is in the process for the intake of a new air/fuel mixture through intake valve 8 of this HP cylinder 2, which has just opened. The exhaust valve 9 of the HP cylinder 2 is in the process of closing and allows for the sweeping of the residual combusted gases towards the LP cylinder 1 through the transfer channel 16, on the left, via the arrival of the fresh mixture. The piston 4 of the central LP cylinder 1 is in the process of rising and flushes most of the combusted gases towards the exhaust system through the exhaust valve 7 of this LP cylinder, which is open. A portion of the exhaust gases is sent towards the transfer channel 17, on the right, through the auxiliary transfer valve 24, on the right, of which the rising is that of the opening “plateau” mentioned hereinabove (see FIG. 7). Inside the HP cylinder 3, on the right, the combustion has just taken place while the corresponding piston 6 has just started its descent. The two corresponding valves 10, 11 are closed.

FIG. 9. The cranks of the HP cylinders are located at an angle equal to 95° in relation to the upper vertical position. The piston 5 of the HP cylinder 2, located on the left in the figure, continues its descent and is in the process for the intake of a new air/fuel mixture through the intake valve 8 of this HP cylinder 2, which is open while the exhaust valve 9 of the HP cylinder 2, on the left, is closed. The piston 4 of the central LP cylinder 1 has just passed by its TDC, starts its descent and begins to admit the combusted gases coming from the HP cylinder 3, on the right, which pass through the exhaust valve 11 of this HP cylinder 3, on the right, the transfer channel 17, on the right side, and the auxiliary transfer valve 24, on the right, the two valves being open. The exhaust valve 7 of the LP cylinder 1 and the auxiliary transfer valve 23, on the left, are closed. The piston 6 of the HP cylinder 3, on the right, continues his descent and is located midway between its TDC and BDC, continuing the expansion of the combusted gases and by producing as such useful work.

FIG. 10. The cranks of the HP cylinders are located at an angle equal to 185° in relation to the upper vertical position. The piston 5 of the HP cylinder 2, located on the left in the figure, starts its ascension again and will compress the new air/fuel mixture. The intake valve 8 of this HP cylinder 2, on the left, will soon close while the exhaust valve 9 of this same HP cylinder 2, on the left, is closed. The piston 4 of the central LP cylinder 1 continues its descent and is located midway between its TDC and BDC while still continuing to admit the combusted gases coming from the HP cylinder 3, on the right. These combusted gases pass through the exhaust valve 11 of the HP cylinder 3, on the right, the transfer channel 17, on the right, and the auxiliary transfer valve 24, on the right, the two valves being open while the piston 6 of this HP cylinder 3 simultaneously expands these combusted gases, producing as such useful work. The exhaust valve 7 of the LP cylinder and the auxiliary transfer valve 23 on the left are closed. The piston 6 of the HP cylinder on the right starts to ascend again to sweep the combusted gases through the transfer channel 17 towards the central LP cylinder while the piston 4 of the LP cylinder continues its descent towards its BDC. Starting from this moment, it is only the piston of the LP cylinder 1 that is producing useful work, the piston 6 of the HP cylinder 3, on the right, consuming work as it rises back up.

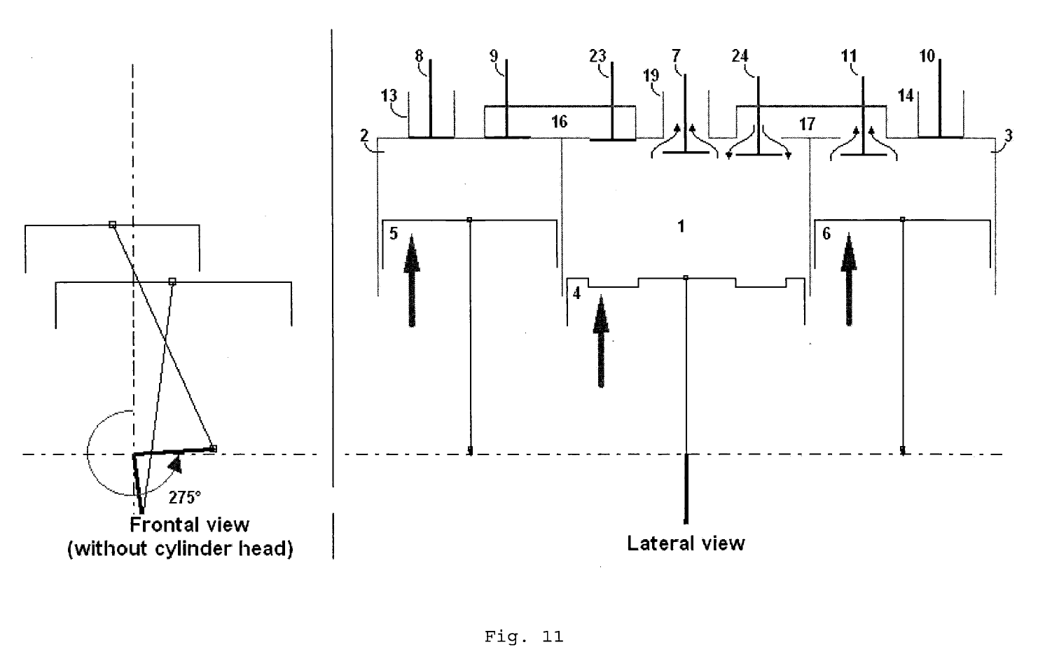

FIG. 11. The cranks of the HP cylinders 2 and 3 are located at an angle equal to 275° in relation to the upper vertical position. The piston 5 of the HP cylinder 2, located on the left in the figure, continues to ascend again and compresses the new air/fuel mixture. All of the valves 8, 9 of the HP cylinder 2, on the left, are closed. The piston 4 of the central LP cylinder 1 is located close to its BDC and starts to ascend again. The exhaust valve 7 of the LP cylinder in question has just opened in order to exhaust, towards the exhaust system, the combusted gases contained in this same LP cylinder. The piston 6 of the HP cylinder 3, on the right, continues to ascend again and continues to sweep, towards the LP cylinder 1, the combusted gases contained in this HP cylinder 3 and this, through the exhaust valve 11, on the right, the transfer channel 17, on the right, and the auxiliary transfer valve 24, the two valves being open.

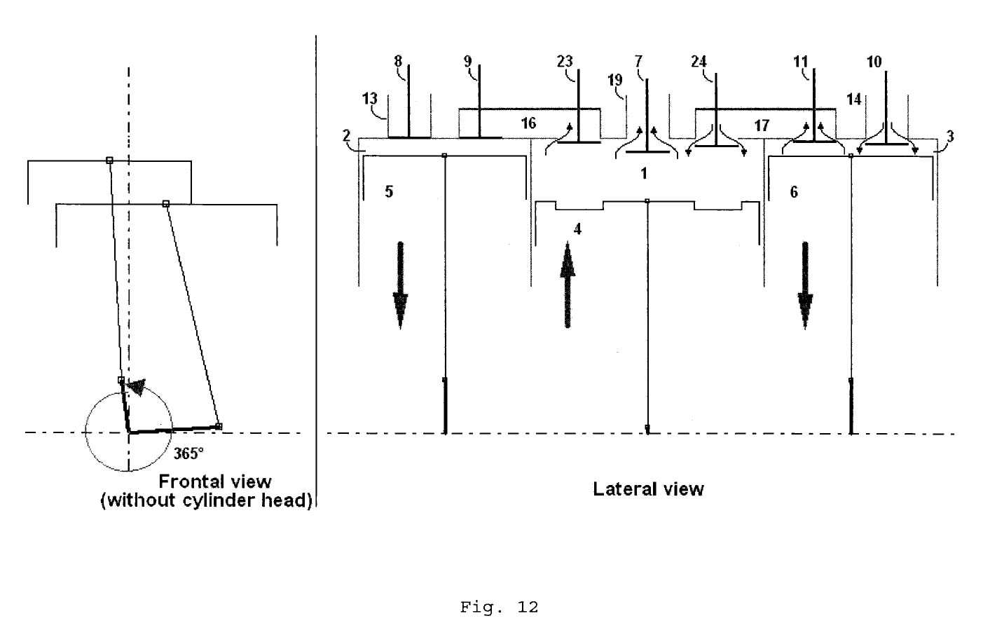

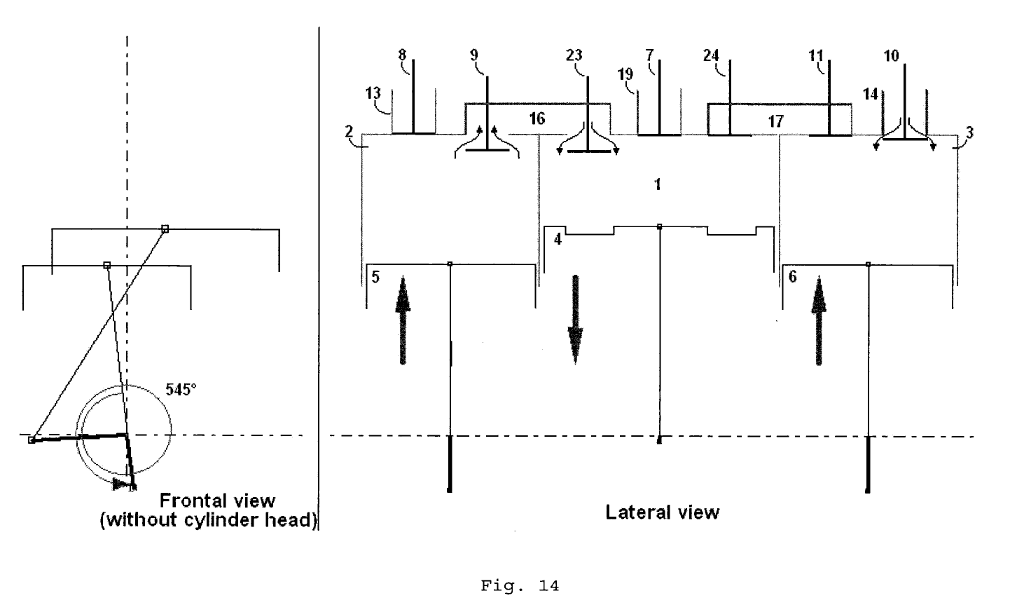

FIG. 12, FIG. 13, FIG. 14 and FIG. 15. A new cycle starts with the intake of a new air/fuel mixture in the HP cylinder 3, located on the right in these figures, and the different phases correspond to those figures in FIG. 8, FIG. 9, FIG. 10 and FIG. 11 by inversing the left and right sides.

FIG. 16: This figure shows a key for the description of the operation of the four-stroke-and-a-half internal combustion engine with 2 groups of 3 opposing cylinders with crankshaft at a 90° angle in FIGS. 17 to 20.

The symbols used show the various states of the gaseous fluid in the engine. The symbols in the form of an arrow show that state of the gaseous fluid during the movements of the latter, i.e. the moments when the fluid either exits a cylinder, or penetrates into a cylinder.

So:
(A) represents the intake of air/fuel mixture.
(B) represents the compression of the air/fuel mixture.
(C) represents the combustion.
(D) represents the transfer of the combusted gases from the HP cylinder to the LP cylinder.
(E) represents the transfer of the exhaust of the combusted gases.

FIGS. 17 to 20 are schematic representations of the operation of a four-stroke-and-a-half internal combustion engine comprising two groups of 3 opposed cylinders and of which the crankshaft is positioned respectively at 0°, 90°, 180° and 270°.

FIG. 17: The piston of the HP cylinder 30 reaches its TDC and the compressed air/fuel mixture has just been lit. The piston of the HP cylinder 30a reaches its BDC and continues to transfer the combusted gases towards the adjacent LP cylinder 32a of which the piston continues its downstroke for a second expansion of the combusted gases. The piston of the HP cylinder 31 also reaches its TDC and starts its downstroke during which an air/fuel mixture intake will occur into the corresponding cylinder. The piston of the adjacent LP cylinder 32 is in the process of rising towards its TDC and the combusted gases contained in the corresponding cylinder are flushed towards the exhaust system. The piston of the HP cylinder 31a reaches its BDC at the end of the downstroke during which the corresponding cylinder has been filled with a new air/fuel mixture.

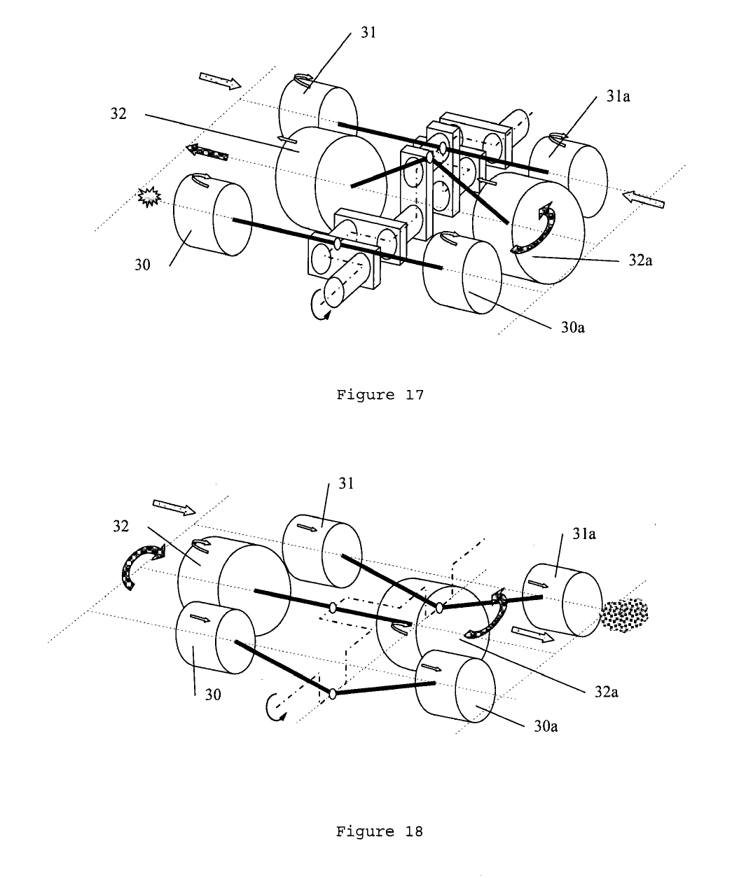

FIG. 18: The piston of the HP cylinder 30 is in the process of descending towards its BDC and expands the combusted gases a first time. The piston of the HP cylinder 30a is in the process of rising towards its TDC and continues to transfer the combusted gases towards the adjacent LP cylinder 32a of which the piston has just reached its BDC. The piston of the HP cylinder 31 is in the process of descending towards its BDC and the corresponding cylinder continues to carry out an air/fuel mixture intake. The piston of the adjacent LP cylinder 32 reaches its TDC and the transfer of the combusted gases starting from the adjacent HP cylinder 30 will begin for a second expansion. The piston of the HP cylinder 31a is in the process of rising towards its TDC to compress the air/fuel mixture intake.

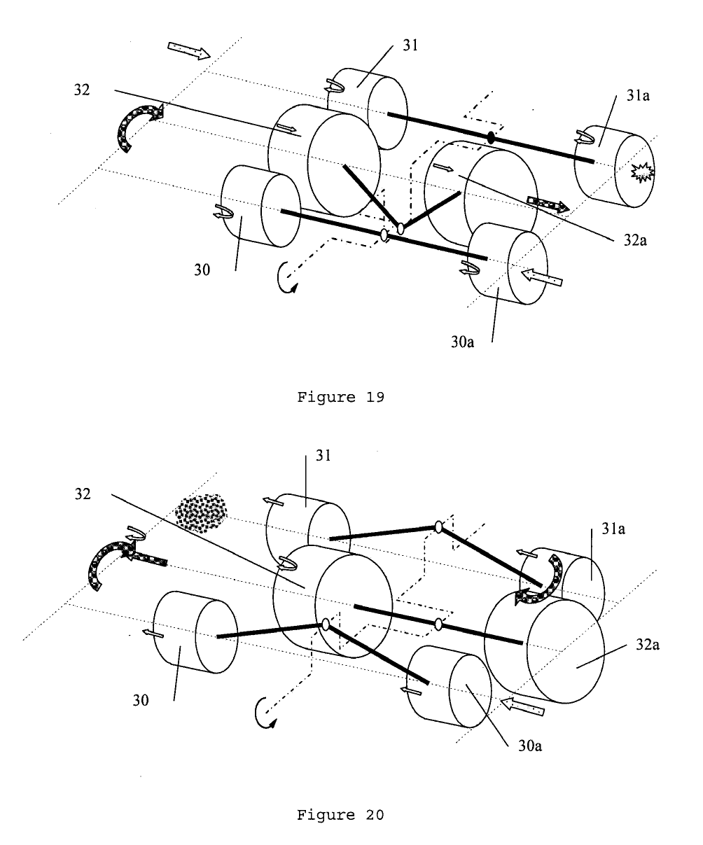

FIG. 19: The piston of the HP cylinder 31a reaches its TDC and the compressed air/fuel mixture has just been lit. The piston of the HP cylinder 30 reaches its BDC and continues to transfer the combusted gases towards the adjacent LP cylinder 32, of which the piston continues its downstroke for a second expansion of the combusted gases. The piston of the HP cylinder 30a also reaches its TDC and starts its downstroke during which an air/fuel mixture intake will be carried out into the corresponding cylinder. The piston of the LP cylinder 32a is in the process of rising towards its TDC and the combusted gases contained in the corresponding cylinder are flushed towards the exhaust system. The piston of the HP cylinder 31 reaches its BDC at the end of the downstroke during which the corresponding cylinder has been filled with a new air/fuel mixture.

FIG. 20: The piston of the HP cylinder 31a is in the process of descending towards its BDC and expands the combusted gases a first time. The piston of the HP cylinder 30 is in the process of rising towards its TDC and continues to transfer the combusted gases towards the adjacent LP cylinder 32 of which the piston has just reached its BDC. The piston of the HP cylinder 30a is in the process of descending towards its BDC and the corresponding cylinder continues to carry out an air/fuel mixture intake. The piston of the adjacent LP cylinder 32a reaches its TDC and the transfer of the combusted gases starting from the adjacent HP cylinder 31a will begin for a second expansion. The piston of the HP cylinder 31 is in the process of rising towards its TDC to compress the air/fuel mixture intake.

1. Method for improving an internal combustion engine of the type comprising at least one cylinder which includes a variable volume working chamber by the displacement in this cylinder of a piston between a top dead center position and a bottom dead center position, to each such cylinder being associated means of admitting and of evacuating a gaseous fluid, the piston of each such cylinder being connected to a crankshaft of said engine, this engine using:
a) on the one hand, at least one such cylinder (1) functioning as a low-pressure cylinder according to a two-stroke operation, which includes the intake accompanied by the expansion producing a useful work during each stroke of the piston of this low-pressure cylinder (1) towards its bottom dead center and the exhaust of a gaseous fluid during each stroke of the piston (4) towards its top dead center, and
b) on the other hand, two such cylinders (2, 3) functioning as high-pressure combustion cylinders according to a four-stroke operation, which includes the intake of air or of an air-fuel mixture during the first stroke of the piston of each of said combustion cylinders (2, 3) towards its bottom dead center, the compression of the air or of an air-fuel mixture during the first stroke of the piston towards its top dead center, followed by the combustion, the expansion of the combusted gases during the second stroke of the piston towards its bottom dead center producing a useful work and the delivery of the combusted gases during the second stroke of the piston towards its top dead center, the capacity displacement of each of the combustion cylinders (2, 3) being less than that of the low-pressure cylinder (1), the combustion cylinders (2, 3) delivering alternatively their combusted gases towards the low-pressure cylinder (1) for a second expansion of the combusted gases, characterized in that the total expansion rate is increased by having intervene a portion of the capacity displacement of the high-pressure cylinders in the maximum expansion volume and this, without increasing the capacity displacement of said engine, or the compression ratio of the high-pressure cylinders, or the dead volume of the low-pressure cylinder, or the volume of the transfer channel of the combusted gases of the high-pressure cylinders towards the low-pressure cylinder.

2. Internal combustion engine for the implementation of the method set forth in claim 1, of the type comprising at least one cylinder which includes a variable volume working chamber by the displacement in this cylinder of a piston between a top dead center position and a bottom dead center position, to each such cylinder being associated means of admitting and of evacuating a gaseous fluid, the piston of each such cylinder being connected to a crankshaft of said engine, this engine using:
a) on the one hand at least one such cylinder (1) functioning as a low-pressure cylinder according to a two-stroke operation, which includes the intake accompanied by the expansion producing a useful work during each stroke of the piston of this low-pressure cylinder (1) towards its bottom dead center and the exhaust of a gaseous fluid during each stroke of the piston (4) towards its top dead center, and
b) on the other hand, two such cylinders (2, 3) functioning as high-pressure combustion cylinders according to a four-stroke operation, which includes the intake of air or of an air-fuel mixture during the first stroke of the piston of each of said combustion cylinders (2, 3) towards its bottom dead center, the compression of the air or of an air-fuel mixture during the first stroke of the piston towards its top dead center, followed by the combustion, the expansion of the combusted gases during the second stroke of the piston towards its bottom dead center producing a useful work and the delivery of the combusted gases during the second stroke of the piston towards its top dead center, the capacity displacement of each of the combustion cylinders (2, 3) being less than that of the low-pressure cylinder (1), the combustion cylinders (2, 3) delivering alternatively their combusted gases towards the low-pressure cylinder (1) for a second expansion of the combusted gases, characterized in that the cranks (27) of the crankshaft, to which are connected the connecting rods (29) attached to the pistons (5; 6) of the high-pressure cylinders supplying alternatively the same low-pressure cylinder, are parallel in relation to one another and form with the crank (26), to which is connected the connecting rod (28) attached to the piston of said low-pressure cylinder (1), an angle of a magnitude of 90° in such a way that the piston (4) of this low-pressure cylinder reaches its top dead center substantially before the pistons (5; 6) of the adjacent high-pressure cylinders reach their respective bottom dead center.

3. Internal combustion engine for the implementation of the method set forth in claim 1, of the type comprising at least one cylinder which includes a variable volume working chamber by the displacement in this cylinder of a piston between a top dead center position and a bottom dead center position, to each such cylinder being associated means of admitting and of evacuating a gaseous fluid, the piston of each such cylinder being connected to a crankshaft of said engine, this engine using:
a) on the one hand at least one such cylinder (1) functioning as a low-pressure cylinder according to a two-stroke operation, which includes the intake accompanied by the expansion producing a useful work during each stroke of the piston of this low-pressure cylinder (1) towards its bottom dead center and the exhaust of a gaseous fluid during each stroke of the piston (4) towards its top dead center, and
b) on the other hand, two such cylinders (2, 3) functioning as high-pressure combustion cylinders according to a four-stroke operation, which includes the intake of air or of an air-fuel mixture during the first stroke of the piston of each of said combustion cylinders (2, 3) towards its bottom dead center, the compression of the air or of an air-fuel mixture during the first stroke of the piston towards its top dead center, followed by the combustion, the expansion of the combusted gases during the second stroke of the piston towards its bottom dead center producing a useful work and the delivery of the combusted gases during the second stroke of the piston towards its top dead center, the capacity displacement of each of the combustion cylinders (2, 3) being less than that of the low-pressure cylinder (1), the combustion cylinders (2, 3) delivering alternatively their combusted gases towards the low-pressure cylinder (1) for a second expansion of the combusted gases, characterized in that on the one hand the axis of the high-pressure cylinders (2; 3) is displaced in relation to the axis of the crankshaft (12) in such a way that the crank (27), whereto is attached the connecting rod (29) of the piston (5; 6) of the high-pressure cylinder, is located on the same side, in relation to the axis of said crankshaft (12), as the axis of this high-pressure cylinder (2; 3) at the moment when the piston (5; 6) of this high-pressure cylinder, being located midway between its top dead center and its bottom dead center, is in the process of descending and in that on the other hand the axis of the low-pressure cylinder (1) is displaced in relation to the axis of said crankshaft (12) in such a way that the crank (26), whereto is attached the connecting rod (28) of the piston (4) of said low-pressure cylinder (1), is located on the same side, in relation to the axis of this crankshaft (12), as the axis of the low-pressure cylinder (1) at the moment when the piston (4) of this low-pressure cylinder, being located midway between its bottom dead center and its top dead center, is in the processes of ascending.

4. Internal combustion engine for the implementation of the method set forth in claim 1, of the type comprising at least one cylinder which includes a variable volume working chamber by the displacement in this cylinder of a piston between a top dead center position and a bottom dead center position, to each such cylinder being associated means of admitting and of evacuating a gaseous fluid, the piston of each such cylinder being connected to a crankshaft of said engine, this engine using:
a) on the one hand at least one such cylinder (1) functioning as a low-pressure cylinder according to a two-stroke operation, which includes the intake accompanied by the expansion producing a useful work during each stroke of the piston of this low-pressure cylinder (1) towards its bottom dead center and the exhaust of a gaseous fluid during each stroke of the piston (4) towards its top dead center, and
b) on the other hand, two such cylinders (2, 3) functioning as high-pressure combustion cylinders according to a four-stroke operation, which includes the intake of air or of an air-fuel mixture during the first stroke of the piston of each of said combustion cylinders (2, 3) towards its bottom dead center, the compression of the air or of an air-fuel mixture during the first stroke of the piston towards its top dead center, followed by the combustion, the expansion of the combusted gases during the second stroke of the piston towards its bottom dead center producing a useful work and the delivery of the combusted gases during the second stroke of the piston towards its top dead center, the capacity displacement of each of the combustion cylinders (2, 3) being less than that of the low-pressure cylinder (1), the combustion cylinders (2, 3) delivering alternatively their combusted gases towards the low-pressure cylinder (1) for a second expansion of the combusted gases, characterized in that:
a) the cranks (27) of the crankshaft, to which are connected the connecting rods (29) attached to the pistons (5; 6) of the high-pressure cylinders supplying alternatively the same low-pressure cylinder, are parallel in relation to one another and form with the crank (26), to which is connected the connecting rod (28) attached to the piston of said low-pressure cylinder (1), an angle of a magnitude of 90° in such a way that the piston (4) of this low-pressure cylinder reaches its top dead center substantially before the pistons (5; 6) of the adjacent high-pressure cylinders reach their respective bottom dead center, and
b) on the one hand the axis of the high-pressure cylinders (2; 3) is displaced in relation to the axis of the crankshaft (12) in such a way that the crank (27), whereto is attached the connecting rod (29) of the piston (5; 6) of the high-pressure cylinder, is located on the same side, in relation to the axis of said crankshaft (12), as the axis of this high-pressure cylinder (2; 3) at the moment when the piston (5; 6) of this high-pressure cylinder, being located midway between its top dead center and its bottom dead center, is in the process of descending and on the other hand the axis of the low-pressure cylinder (1) is displaced in relation to the axis of said crankshaft (12) in such a way that the crank (26), whereto is attached the connecting rod (28) of the piston (4) of said low-pressure cylinder (1), is located on the same side, in relation to the axis of this crankshaft (12), as the axis of the low-pressure cylinder (1) at the moment when the piston (4) of this low-pressure cylinder, being located midway between its bottom dead center and its top dead center, is in the processes of ascending.

5. Internal combustion engine as set forth in any of claims 2 to 4, characterized in that it comprises two groups of three inline cylinders, these groups forming an angle between themselves of 180° and being located on either side of a single three-crank crankshaft (26; 27), the two cranks being located at the ends of this crankshaft (27) being parallel and connected to the pistons (5; 6) of the high-pressure cylinders by the corresponding connecting rods (27), the third crank (26) being located in the middle and being connected to the pistons (4) of the low-pressure cylinders by the corresponding connecting rods (29), this last crank (26) forming an angle of approximately 90° with the other two cranks (27), in such a way that the pistons (4) of the low-pressure cylinders reach their respective top dead center substantially before the pistons (5; 6) of the adjacent high-pressure cylinders (2; 3) reach their respective bottom dead center.

6. Internal combustion engine according to one of claims 2 to 4, characterized in that it comprises transfer channels which each include a main transfer valve (9; 11) and an auxiliary transfer valve (23; 24) which functions as an intake valve of the low-pressure cylinder, the main transfer valve (9; 11) and this auxiliary transfer valve (23; 24) of the transfer channel (16; 17) which opens into the corresponding high-pressure cylinder (2; 3) being configured in such a way that said auxiliary valve (23; 24) opens substantially before the piston (4) of the low-pressure cylinder reaches its top dead center, instant close to which will start the transfer of the combusted gases of the corresponding high-pressure cylinder (2; 3) through said transfer channel (16; 17) in such a way that this transfer channel (16; 17) is pressurized by a portion of the residual combusted gases contained in the low-pressure cylinder (1) before the opening of the main transfer valve (9; 11) functioning as an exhaust valve of said corresponding high-pressure cylinder (2; 3) and blocking said transfer channel (16; 17) on the side of this high-pressure cylinder (2; 3) and without too greatly increasing the depth (25) of the valve pocket arranged in the upper surface of the piston (4) of the low-pressure cylinder in order to avoid all contact between the auxiliary transfer valve (23; 24) and the piston (4) of the low-pressure cylinder.

7. Internal combustion engine according to one of claims 2 to 4, characterized in that the low-pressure cylinder (1) comprises one or several exhaust valves (7) controlled by a camshaft turning at the speed of the crankshaft.

8. Internal combustion engine according to one of claims 2 to 4, characterized in that the low-pressure cylinder (1) comprises one or several exhaust valves (7) controlled by a camshaft turning at the speed of the crankshaft, this camshaft being provided with balance weights arranged and dimensioned in such a way as to reduce the vibrations of the engine generated by other existing weights and displacing at the rotation frequency of the crankshaft.
